(19) United States
(12) Patent Application Publication
(10) Pub. No.: US 2026/0210723 A1
(43) Pub. Date: Jul. 23, 2026

(54) VEHICLE DRIVING ASSISTANCE SYSTEM AND METHOD

(71) Applicant: Ford Global Technologies, LLC, Dearborn, MI (US)

(72) Inventors: Brendan F. Diamond, Naples, FL (US); Anthony Maraldo, Southgate, MI (US); Keith Weston, Canton, MI (US); Andrew Brown, Royal Oak, MI (US); Michael Alan McNees, Flat Rock, MI (US)

(73) Assignee: Ford Global Technologies, LLC, Dearborn, MI (US)

(21) Appl. No.: 19/032,662

(22) Filed: Jan. 21, 2025

(51) Int. Cl. G01C 21/34; G01C 21/00; G01C 21/36

(52) U.S. Cl. CPC G01C 21/3407; G01C 21/3647; G01C 21/3815

(57) ABSTRACT

A vehicle driving assistance system includes a plurality of sensors sensing characteristics of a roadway proximate to the vehicle. A plurality of data sets includes crowd sourcing data and user feedback data providing known past characteristics of the roadway. A human machine interface provides an output with vehicle maneuvering guidance for the vehicle. A controller processes the sensed characteristics of the roadway and the known past characteristics of the roadway and generates the maneuvering guidance based on the sensed characteristics of the roadway and the known past roadway characteristics.

### FIELD OF THE DISCLOSURE

The present disclosure generally relates to motor vehicle navigation assistance, and more particularly relates to driver assistance for a motor vehicle to provide vehicle maneuvering guidance, particularly for constricted driving paths.

### BACKGROUND OF THE DISCLOSURE

Motor vehicles are commonly equipped with various kinds of driving assistance systems including park assist systems and lane change assist systems, for example. Large vehicles, particularly tow vehicles towing a trailer, along constricted driving paths such as performing tight turning maneuvers or driving through congested areas can be challenging. It would be desirable to provide for a vehicle driving assistance system that enhances the maneuverability of the motor vehicle.

### SUMMARY OF THE DISCLOSURE

According to a first aspect of the present disclosure, a vehicle driving assistance system includes a plurality of sensors sensing characteristics of a roadway proximate to the vehicle. A plurality of data sets includes crowd sourcing data and user feedback data providing known past characteristics of the roadway. A human machine interface provides an output with vehicle maneuvering guidance for the vehicle. A controller processes the sensed characteristics of the roadway and the known past characteristics of the roadway and generates the maneuvering guidance based on the sensed characteristics of the roadway and the known past roadway characteristics.

Embodiments of the first aspect of the present disclosure can include any one or a combination of the following features:

the controller generates the maneuvering guidance further based on the plurality of data sets including trailer characteristics of a trailer towed with the vehicle;

the known past roadway characteristics include prior mapped data;

the known past roadway characteristics include Google Earth data;

the known past roadway characteristics include prior recorded driving data acquired by the plurality of sensors;

the known paths roadway characteristics include drone map data acquired by one or more drones;

the human machine interface comprises a display;

the generated maneuvering guidance are provided with projected one or more driving guidance lines on the display;

the one or more projected driving guidance lines comprise a pair of augmented reality lines; and

the display comprises an infotainment screen.

According to a second aspect of the present disclosure, a vehicle has a plurality of wheels including one or more steerable wheels, a plurality of sensors sensing characteristics of a roadway upon which the vehicle is traveling and a vehicle driving assistant system. The vehicle driving assistance system includes a plurality of sensors sensing characteristics of a roadway proximate to the vehicle. A plurality of data sets includes crowd sourcing data and user feedback data providing known past characteristics of the roadway. A human machine interface provides an output with vehicle maneuvering guidance for the vehicle. A controller processes the sensed characteristics of the roadway and the known past characteristics of the roadway and generates the maneuvering guidance based on the sensed characteristics of the roadway and the known past roadway characteristics.

Embodiments of the second aspect of the present disclosure can include any one or a combination of the following features:

a tow hitch configured to tow a trailer;

the human machine interface comprises a display, and the generated maneuvering guidance is provided with one or more projected driving guidance lines on the display;

the one or more projected driving guidance lines comprise a pair of augmented reality lines; and

a steering wheel configured to direct the one or more steerable wheels, wherein the maneuvering guidance include steering wheel control instructions.

The present disclosure further includes a method of assisting a vehicle in driving on a roadway. The method includes the steps of sensing characteristics of the roadway proximate to the vehicle, receiving a plurality of data sets including crowd sourcing data and user feedback data providing known past characteristics of the roadway, providing an output with vehicle maneuvering guidance for maneuvering the vehicle, processing the sensed characteristics of the roadway and the known past roadway characteristics and generating the maneuvering guidance based on the sensed characteristics of the roadway and the known past roadway characteristics.

Embodiments of the third aspect of the present disclosure can include any one or a combination of the following steps and features:

the step of displaying the maneuvering guidance on a display including projecting driving guidance lines;

the projected lines include augmented reality lines;

the step of sensing characteristics of a trailer connected to the vehicle and generating the maneuverability guidance to maneuver the vehicle and trailer; and

the known past roadway characteristics include prior mapped data.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top view of a motor vehicle and trailer maneuvering a constricted driving path on a roadway with a driving assistance system, according to one exemplary vehicle driving scenario;

FIG. 2 is a schematic view of a human machine interface display of the driving assistance system illustrating displayed driver guidance for maneuvering the motor vehicle on a constricted driving path;

FIG. 3 is a block diagram illustrating the vehicle driving assistance system and controls therefor; and

FIG. 4 is a flow diagram illustrating a routine for providing driving assistance guidance according to the vehicle driving assistance system.

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

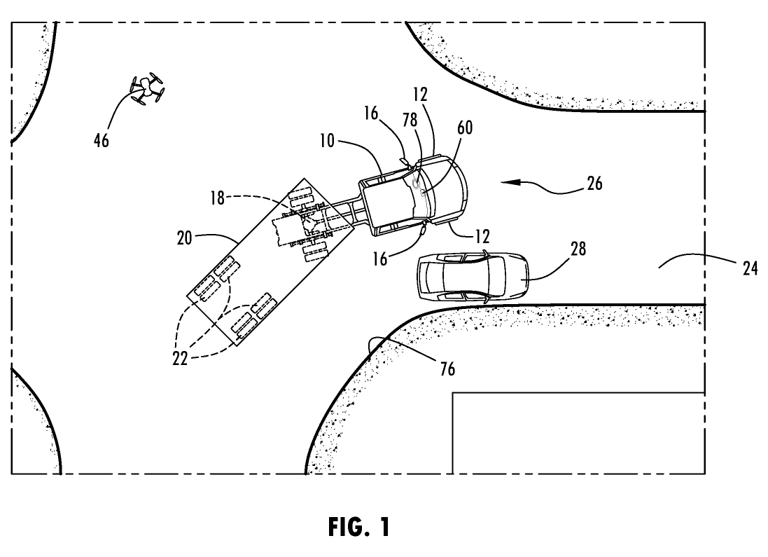

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle driving assistance system and method of assisting a vehicle in driving on a roadway. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-4, a vehicle driving assistance system 30 and method are illustrated for assisting a driver of a motor vehicle 10 with driver guidance to maneuver the motor vehicle 10 on a roadway, particularly traveling along a constricted driving path. The vehicle driving assistance system 30 includes a plurality of sensors sensing characteristics of a roadway 24 proximate to the motor vehicle 10 and a plurality of data sets including crowd sourcing data and user feedback data providing known past characteristics of the roadway 24. The vehicle driving assistance system 30 includes a human machine interface such as a display providing an output with vehicle maneuvering guidance for maneuvering the motor vehicle 10. A controller processes the sensed characteristics of the roadway and the known past characteristics of the roadway and generates the maneuvering guidance based on the sensed characteristics of the roadway and the known past roadway characteristics.

With particular reference to FIG. 1, the motor vehicle 10 is generally illustrated configured as a tow vehicle towing a trailer 20 and maneuvering the motor vehicle 10 and trailer 20 combination along a constricted driving path 26 on a roadway 24, according to one example of a driving scenario. The motor vehicle 10, as shown in one example, is a wheeled motor vehicle having a plurality of wheels including a pair of front steerable wheels 12 and a pair of rear wheels 14. The motor vehicle 10 is equipped with a steering wheel 78 configured to enable a driver of the motor vehicle 10 to turn the pair of front steerable wheels 12 to steer the motor vehicle 10 along a driving path. The motor vehicle 10 is shown in one example as a towing vehicle having a tow hitch 18 configured to engage and connect to a Kingpin or other receiver on the front end of a trailer 20. In the example shown, the tow hitch 18 may be configured as a fifth wheel hitch, however, it should be appreciated that the tow hitch 18 may be otherwise configured as a receiver hitch, a gooseneck hitch, a weight distribution hitch or a pintle hitch, according to various examples.

It should further be appreciated that the trailer 20 may include a plurality of wheels 22 which enable the trailer 20 to follow the motor vehicle 10 and the trailer pivots at the hitch connection 18. As the motor vehicle 10 maneuvers and makes turns, the trailer 20 may follow the tow vehicle on a more direct path which may create challenges in maneuvering the motor vehicle 10 and trailer 20 combination, particularly along constricted driving paths. For example, the motor vehicle 10 may be maneuvered along a constricted driving path 26 on a roadway 24 that involves making tight turning maneuvers within the confines of a curb 76 which generally defines a border on the roadway 24 and to avoid contact with the curb 76 and to avoid contact with other vehicles 28 and other objects which may be present at various locations on the roadway 24.

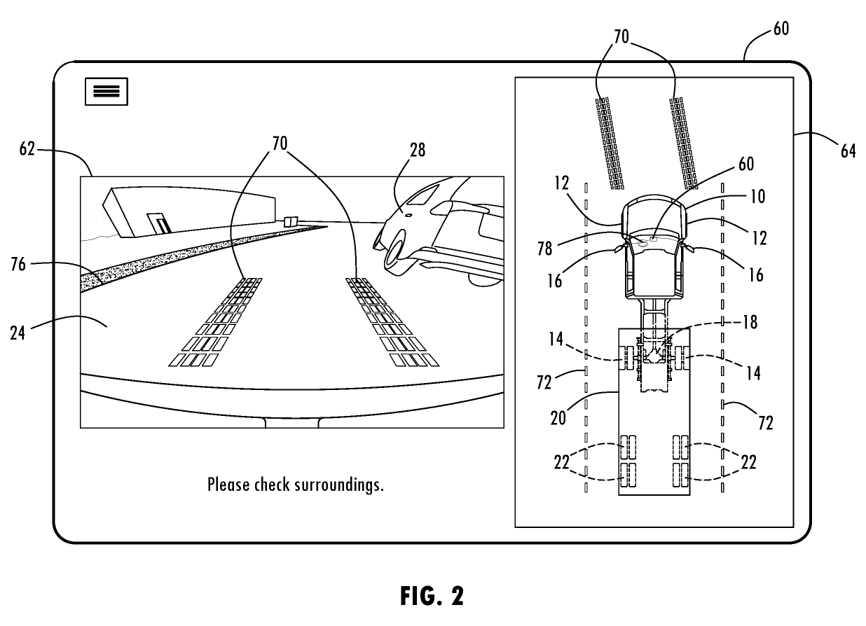

The vehicle driving assistance system 30 includes a human machine interface (HMI) which is illustrated in one embodiment as a display 60 as an output device, as shown in FIG. 2 for providing guidance to the driver of the motor vehicle 10 to operate the steering wheel 78 to steer the motor vehicle 10 on a guided path. The display 60 may be a touchscreen display, for example, generally located forward of the driver’s seat of the motor vehicle 10, such as forward of a center console or proximate to the windshield or forward of the steering wheel 78. In the example shown, the touchscreen display 60 provides as an output a forward guidance view 62 for viewing by the driver of the vehicle which illustrates the roadway, generally forward of the motor vehicle 10 as the motor vehicle 10 progresses in a forward direction to assist with providing guidance lines 70 for the driver of the motor vehicle 10 to follow. In the example shown, the guidance lines 70 present a guidance path, such as for maneuvering the motor vehicle 10 into a parking spot adjacent to another vehicle 28 or along a path on a roadway. It should be appreciated that the guidance view 60 may include a rearward facing guidance view when the motor vehicle 10 is operated in backup or reverse direction.

The touchscreen display 60 further illustrates as an output a pair of guidance lines 70 overlayed onto a top bird’s eye view of the vehicle and surrounding area for the driver to follow to maneuver the steering wheel 78 to drive the motor vehicle 10 along a guidance path. In the example shown, the pair of guidance lines 70 may include augmented reality guidance lines which may be used to guide the motor vehicle 10 within a parking space shown by parking space guidance lines 72. The guidance lines may be used to guide the vehicle along any guidance path. The augmented reality guidance lines are overlaid onto the camera generated images to provide line of sight driving guidance instructions for the driver to follow. As such, the vehicle operator may view one or more augmented reality guidance lines 70 both from a forward or rearward looking view and a top bird’s eye view and may steer the motor vehicle 10 according to the guidance lines 70. It should be appreciated that the guidance views 62 and 64 are generated from camera images generated by a plurality of cameras located around the motor vehicle 10 including cameras located at the front of the motor vehicle 10, the rear of the motor vehicle 10 and along the sides and the top of the motor vehicle 10. The camera images generated by the cameras may be displayed along with the pair of guidance lines 70 overlaid onto the images.

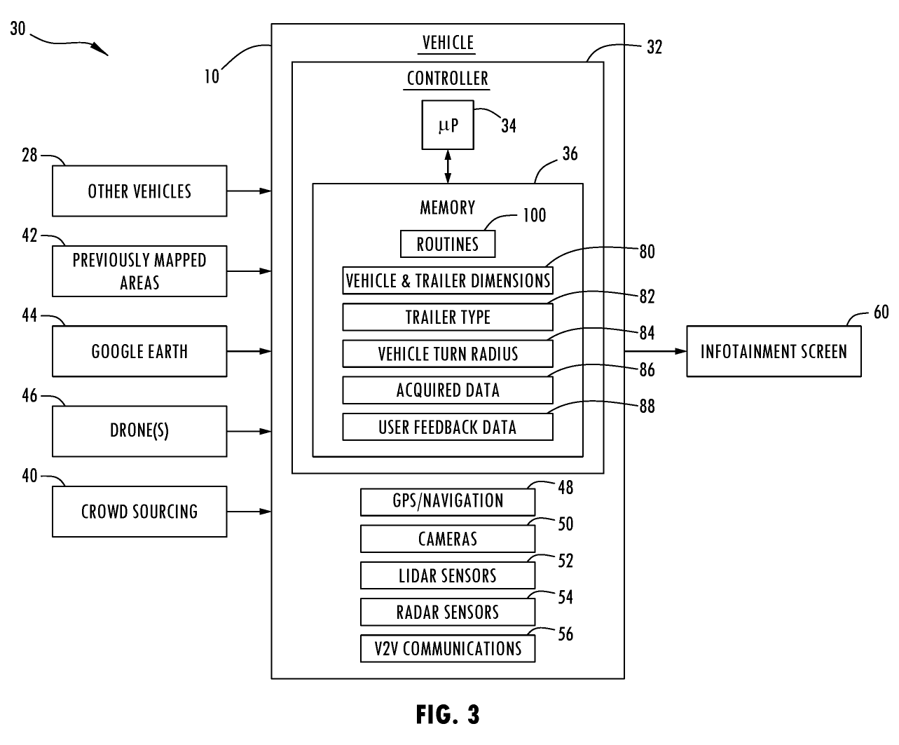

Referring to FIG. 3, the vehicle driving assistance system 30 is illustrated having a controller 32 located on board the motor vehicle 10. In addition, the motor vehicle 10 is equipped with a plurality of imaging devices shown as cameras 50 which may be located at various locations on the vehicle such as, for example, at the front of the motor vehicle 10, at the rear of the motor vehicle 10, along the left and right sides of the motor vehicle 10 such as within a pair of powered folding mirrors 16, and on top of the motor vehicle 10. In addition, the motor vehicle 10 is equipped with a plurality of lidar sensors 52 and radar sensors 54 which may be located at various locations such as the front, rear and sides of the motor vehicle 10 to sense objects such as roadway features, other vehicles, pedestrians and animals, for example, on opposite sides and forward and rearward of the motor vehicle 10.

The motor vehicle 10 is further equipped with vehicle-to-vehicle (V2V) communication circuitry 56 which enables vehicle communications with other vehicles such as to acquire historical acquired data or current acquired data, particularly data pertaining to the constricted driving paths and driving traffic at or near the motor vehicle 10. The V2V communication circuitry 56 may include one or more transceivers for communication with transceivers on other vehicles. The motor vehicle 10 is further illustrated coupled to a traffic locating system such as a global positioning system (GPS) 48 for receiving location data which in turn may be used to track the location of the motor vehicle 10 and to operate with a navigation system.

The controller 32 may be configured to include control circuitry configured as a microprocessor 34 having memory 36, according to one example. It should be appreciated that the controller 32 may be a dedicated controller dedicated to providing driver assisted guidance as navigation services or may be a shared controller also performing other tasks. It should be appreciated that the controller 32 may include other analog and/or digital circuitry. The memory 36 includes one or more routines and including routine 100 for providing motor vehicle guidance assistance according to the vehicle driving assistance system 30. Memory 36 may also store data including vehicle and trailer dimensions 80, trailer type 82, vehicle turn radius 84, acquired data 86 and user feedback data 88, for example.

The motor vehicle 10 processes the current sensed characteristics of the roadway proximate to the motor vehicle 10 and known past characteristics of the roadway and generates maneuvering guidance instructions based on the sensed characteristics of the roadway and the known past characteristics of the roadway and provides driving guidance for maneuvering the vehicle to the human machine interface, which in one example is the infotainment screen display 60. The infotainment screen display 60 may provide a visual output for the driver to follow as guidance for maneuvering the motor vehicle 10. It should be appreciated that the human machine interface may otherwise include other outputs such as audible commands output via one or more audio speakers, for example.

The motor vehicle 10 may communicate with various offboard systems which may provide roadway data including GPS location data and dimensions including constricted driving path data for the roadway. The offboard systems may include a crowd sourcing system 40 which provides historical data of the roadway and constricted driving paths as it relates to the motor vehicle 10 driving with and without a trailer. The crowd sourcing system 40 may include historical data sensed or collected by previous vehicles and stored in memory in the cloud or other data storage location. The motor vehicle 10 may also communicate with a previously mapped area system 42 which provides data that was previously sensed and mapped with the motor vehicle 10. The motor vehicle 10 may also communicate with Google Earth system to provide geographic data of the roadway. The motor vehicle 10 may also operate in conjunction with one or more drones 46 which may be used to capture images and provide visual acquired image data that may be transmitted to the motor vehicle 10 and processed by the controller 32. Further, other vehicles 28 may communicate via the vehicle-to-vehicle (V2V) communication circuitry 56 to upload driver maneuvering data pertaining to the roadway and to certain constricted areas of interest. The communication between the motor vehicle 10 and the remote sources may be via cellular or other wireless communication using antenna towers, satellites and with other vehicles, for example.

The vehicle driving assistance system 30 collects the known past roadway characteristics including the crowd sourcing system data 40, previously mapped area system data 42, Google Earth system data 44, drone acquired data 46 and other vehicle collected data 28 and processes the collected data in conjunction with the data acquired by the plurality of sensors onboard the motor vehicle 10 that sense characteristics of the roadway proximate to the motor vehicle 10, and further processes the vehicle driving assistance system routine 100 to generate a driving guidance output for the driver of the motor vehicle 10. The generated driving guidance output may be output as a visual output to the infotainment screen 60 to enable the driver of the motor vehicle to better maneuver the constricted driving path on the roadway.

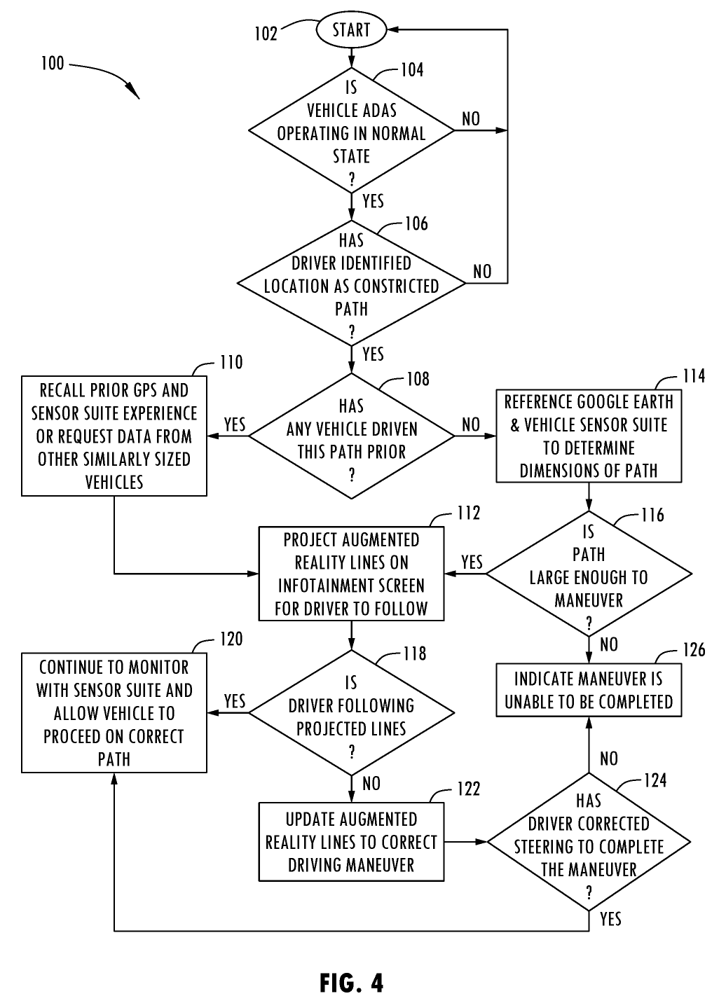

The vehicle driving assistance system routine 100 is illustrated in FIG. 4, according to one embodiment. Routine 100 begins at step 102 and proceeds to decision step 104 to determine if the motor vehicle advanced driver assistance system (ADAS) is operating in the normal state and, if not, returns to start 102. If the vehicle ADAS is operating in the normal state, routine 100 proceeds to decision step 106 to determine if the driver has identified the location of the motor vehicle 10 being on a constricted path and, if not, returns to start 102. If the driver of the vehicle has identified the location to be on a constricted driving path, routine 100 proceeds to decision step 108 to determine if the motor vehicle has driven this constricted driving path previously and, if so, recalls the prior GPS location data and sensor acquired data experienced while driving or requests similar data from other similarly sized vehicles. Routine 100 then proceeds to step 112 to project augmented reality lines on the infotainment screen for the driver to follow as driving guidance. The projected augmented reality lines are generated based on the prior sensed data experienced on the data acquired from the similarly sized vehicles.

If the motor vehicle has not previously driven the current path as determined in decision step 108, routine 100 proceeds to step 114 to reference the Google Earth system and the plurality of vehicle sensors to determine dimensions of the driving path. Next, at decision step 116, routine 100 determines if the driving path is large enough to maneuver the motor vehicle and any trailer connected thereto and, if so, proceeds to step 112 to generate and project the augmented reality lines on the infotainment screen display for the driver to following as driving guidance. If the driving path is not large enough to maneuver the motor vehicle and any trailer connected thereto, routine 100 proceeds to step 126 to indicate to the driver that the driving maneuver is unable to be properly completed.

Once the projected augmented reality lines are displayed on the display to the driver in step 112, routine 100 proceeds to decision step 118 to determine if the driver is following the projected lines to drive the motor vehicle and any trailer connected thereto and, if so, continues to monitor with the plurality of motor vehicle sensors and to allow the motor vehicle to proceed on the correct path. If the driver is not following the projected lines, routine 100 proceeds to step 122 to update the augmented reality lines to correct the driving maneuver and prevent the motor vehicle from contacting one or more objects on the driving path. Thereafter, routine 100 proceeds to decision step 124 to determine if the driver has corrected the vehicle steering to complete the driving maneuver and, if so, continues to monitor with the plurality of sensors and to allow the motor vehicle to proceed on the correct driving path at step 120. Otherwise, routine 100 proceeds to step 126 to indicate that the driving maneuver is unable to be properly completed.

Accordingly, the vehicle driving assistance system 30 and method advantageously provides for driving guidance to the driver of the motor vehicle 10 using compiled known past and sensed data to provide driving maneuvers which is particularly advantageous for maneuvering along constricted driving paths, especially with a trailer connected to the motor vehicle 10.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle driving assistance system for a vehicle, the vehicle driving assistance system comprising:
a plurality of sensors sensing characteristics of a roadway proximate to the vehicle;
a plurality of data sets including crowd sourcing data and user feedback data providing known past characteristics of the roadway;
a human machine interface providing an output with vehicle maneuvering guidance for the vehicle; and
a controller processing the sensed characteristics of the roadway and the known past characteristics of the roadway and generating the maneuvering guidance based on the sensed characteristics of the roadway and the known past roadway characteristics.

2. The vehicle driving assistance system of claim 1, wherein the controller generates the maneuvering guidance further based on the plurality of data sets including trailer characteristics of a trailer towed with the vehicle.

3. The vehicle driving assistance system of claim 1, wherein the known past roadway characteristics include prior mapped data.

4. The vehicle driving assistance system of claim 1, wherein the known past roadway characteristics include Google Earth data.

5. The vehicle driving assistance system of claim 1, wherein the known past roadway characteristics include prior recorded driving data acquired by the plurality of sensors.

6. The vehicle driving assistance system of claim 1, wherein the known paths roadway characteristics include drone map data acquired by one or more drones.

7. The vehicle driving assistance system of claim 1, wherein the human machine interface comprises a display.

8. The vehicle driving assistance system of claim 7, wherein the generated maneuvering guidance are provided with projected one or more driving guidance lines on the display.

9. The vehicle driving assistance system of claim 8, wherein the one or more projected driving guidance lines comprise a pair of augmented reality lines.

10. The vehicle driving assistance system of claim 7, wherein the display comprises an infotainment screen.

11. A vehicle comprising:
a plurality of wheels including one or more steerable wheels;
a plurality of sensors sensing characteristics of a roadway upon which the vehicle is traveling; and
a vehicle driving assistant system, the vehicle driving assistant system comprising:
a plurality of sensors sensing characteristics of a roadway proximate to a vehicle;
a plurality of data sets including crowd sourcing data and user feedback data providing known past characteristics of the roadway;
a human machine interface providing an output with vehicle maneuvering guidance for the vehicle; and
a controller processing the sensed characteristics of the roadway and the known past characteristics of the roadway and generating the maneuvering guidance based on the sensed characteristics of the roadway and the known past roadway characteristics.

12. The vehicle of claim 11, further comprising a tow hitch configured to tow a trailer.

13. The vehicle of claim 12, wherein the human machine interface comprises a display, and wherein the generated maneuvering guidance is provided with one or more projected driving guidance lines on the display.

14. The vehicle of claim 13, wherein the one or more projected driving guidance lines comprise a pair of augmented reality lines.

15. The vehicle of claim 11, further comprising a steering wheel configured to direct the one or more steerable wheels, wherein the maneuvering guidance include steering wheel control instructions.

16. A method of assisting a vehicle in driving on a roadway, the method comprising the steps of:
sensing characteristics of the roadway proximate to the vehicle;
receiving a plurality of data sets including crowd sourcing data and user feedback data providing known past characteristics of the roadway;
providing an output with vehicle maneuvering guidance for maneuvering the vehicle;
processing the sensed characteristics of the roadway and the known past roadway characteristics; and
generating the maneuvering guidance based on the sensed characteristics of the roadway and the known past roadway characteristics.

17. The method of claim 16, further comprising the step of displaying the maneuvering guidance on a display including projecting driving guidance lines.

18. The method of claim 17, wherein the projected lines include augmented reality lines.

19. The method of claim 16, further comprising the step of sensing characteristics of a trailer connected to the vehicle and generating the maneuverability guidance to maneuver the vehicle and trailer.

20. The method of claim 16, wherein the known past roadway characteristics include prior mapped data.
